(19) United States
(12) Patent Application Publication
(10) Pub. No.: US 2009/0233590 A1
(43) Pub. Date: Sep. 17, 2009

(54) METHODS AND DEVICES FOR CONTROLLING RECEIVERS

(75) Inventor: Lee Sinton, Berkshire (GB)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/047,745

(22) Filed: Mar. 13, 2008

(51) Int. Cl. H04M 3/00; H04B 7/00

(52) U.S. Cl. 455/418; 455/41.2

(57) ABSTRACT

Methods and devices for controlling receivers are disclosed. An exemplary method comprises detecting a first event at a device, and in response to the first event, broadcasting a first central signal including a control command, wherein the central signal is transmitted using a frequency modulated signal.

### FIELD OF THE INVENTION

The invention is related to frequency modulation radio transmitters and receivers, and in particular to the control of a radio receiver via a short-range frequency modulation transmitter.

### BACKGROUND ART

In order to benefit from audio playback hardware of other devices, low power radio transmitters are widely implemented in electronic devices. This technique is especially used with electronic devices that are used for audible output of some kind, such as mobile phones, music players or route guidance systems, but do not include adequate loudspeakers for audio broadcast into a larger environment. When such a device is equipped with an internal or external frequency modulation transmitter, i.e. a radio transmitter in the Very High Frequency (VHF) radio band employing frequency modulation (FM), the audio signal may be transmitted to a separate FM receiver device for playback. The frequency range of such receivers and transmitters might be in the range of 87 MHz to 108 MHz for carrying monophonic or stereophonic sound broadcasts. There might be any other frequency ranges possible (further not limiting examples are 76 to 90 MHz and 65.8 to 74 MHz). Since radio receiver devices with effective speakers are widespread in private households or cars, and may easily be installed by a user at any desired location, this allows convenient audio playback even if the actual playback device only has small and low power speakers (such as in a phone headset) or headset connectors.

Several situations are conceivable where the interaction between an electronic device and the radio receiver is deficient from a user's viewpoint. As an example, a user may listen to music from a car radio and then receive a phone call on his mobile phone. In order to have silence during the call, he needs to turn off the car radio, turn down the volume or something similar before taking the call. After the call is terminated, he needs to turn the music back on manually. Such actions may be particularly distracting and thus even harmful when the user is driving a car. Another example is a navigation system in a car. When the user listens to music from a radio station, a CD player, or possibly his mobile music player using a FMTx transmitter as described above, he may not be able to clearly hear a short guidance prompt from the navigation system due to the ambient “noise” of the music player. Usually, prompts such as those of a navigation system are very short and unannounced, and a user thus does not have the possibility to turn down the music volume. Further, it may be annoying to have to control several electronic devices simultaneously, such as a phone, a music player, a route guidance system, and a car hi-fi system, while a user usually only would like to listen to one audio signal at a time. From a manufacturer viewpoint, it is also unsatisfying to have separate full speaker systems for each potential audio device, such as a route guidance system, while other devices would be available for audio output with powerful speaker systems.

### SUMMARY

According to exemplary embodiments of the invention, a method is provided comprising detecting a first event at a device, and in response to said first event, broadcasting a first control signal including a control command, wherein said control signal is transmitted using a frequency modulated signal.

Such a control signal may in these and other embodiments e.g. include a muting command, and/or a frequency change command. A radio frequency parameter may be indicated within the control signal, for example giving a current or future transmission frequency value, or other parameters related to a transmission frequency.

In exemplary implementations, the first event may be an incoming phone call. Alternatively, the first event may be an audio announcement.

In a further embodiment, a method may further comprise detecting a second event at said device, and in response to said second event, broadcasting a second control signal using a frequency modulated signal. The second event may for example be the termination of a phone call, or the completion of an audio announcement.

The method may in some embodiments further comprise starting a first timer having a predetermined expiry time, and on expiring of said time, sending a further control signal.

Furthermore, an exemplary method may comprise checking whether a process triggered by said first event is still active before said sending of a further control signal, and if said process is still active, restarting said first timer. Examples for such a process may be an ongoing phone call, a user input process, an audio announcement, playback of a prompt, or any other process that may occur in a device.

In some embodiments, the first and/or second event (or any event) may be a user input. The user input is not limited to any specific input type, and may e.g. include key inputs, speech input, touch screen operation, or any other input.

According to exemplary embodiments, a method as above may further comprise sending a termination control signal on deactivation of said device. Further, a method may additionally or alternatively include broadcasting an identification signal upon start-up of said device.

In any of these or other embodiments, the control signal(s) may be transmitted on a subcarrier of a frequency modulated carrier radio signal.

Transmission of control signals may in some embodiments be in accordance with the radio data system (RDS) standard, or the radio broadcast data system (RBDS) standard, or any other similar standard. Optionally, the control signals may in some embodiments utilize an open data application (ODA) structure of the RDS or RBDS standard.

It will be understood that any of the above method features may be present in an embodiment alone or in combination, and/or combined with other features, and that several features may lead to further interactions when combined.

According to another exemplary embodiment of the invention, a method may comprise receiving a first control signal on a frequency modulated signal, and in response to said control signal, changing at least one parameter of an audio output function.

Further, some method embodiments may further comprise storing a value of said at least one parameter before changing said parameter.

In some embodiments, the method may further comprise in response to said control signal, starting a timer having a predefined expiry time, and on expiring of said timer, returning said at least one changed parameter of said audio output function to its original parameter value.

According to another embodiment, the method may further comprise receiving a second control signal, and in response to said second control signal, restarting said timer.

In another exemplary embodiment, the method may include receiving a third control signal signal, and in response to said third control signal, returning said at least one changed parameter of said audio output function to its original parameter value.

The changing of audio output parameter may for example include muting an audio output signal, and/or tuning to a defined receiving frequency, and/or switching an audio output to radio frequency signals. Further audio output parameters that may be changed alternatively or additionally are volume, speaker selection, and similar parameters. Besides audio output parameters, it may in some embodiments include changing other parameters of a device, such as display parameters or further functionalities.

According to another exemplary embodiment, the method may further comprise receiving an identification signal. Optionally, a control application may be started in response to said identification signal. Additionally or alternatively, parameters included in said identification signal may be stored or buffered.

According to another aspect, embodiments of the method may include a computer program product including computer program code which, when run on a processing device, executes any of the above method features. Similarly, program code may be available for download from a server, and may, after downloading and running the code, execute any of the above features.

According to another aspect of the invention, an apparatus may be provided comprising an frequency modulating radio transmitter module, at least one functional module, a controller connected to said functional module and said transmitter module, wherein said controller is adapted to detect a first event at said functional module, and to transmit a predefined control signal in response to said event.

As an example, the at least one functional module may be a cellular communication module, an audio player, and/or a route guidance module.

Furthermore, an apparatus may be provided which may comprise an FM radio receiver module, an audio output system including at least one speaker, a controller connected to said receiver module and said audio output system, wherein said controller is adapted to receive a first control signal on a frequency modulated signal, and to change at least one parameter of an audio output function in response to said control signal,

In some embodiments, the apparatus may further comprise a memory element, wherein said controller may be adapted to store parameters included in received control signals in said memory element.

Further, in an exemplary embodiment an apparatus may be provided comprising means for detecting a first event at said apparatus, and means for broadcasting a first control signal including a control command in response to said first event, wherein said control signal is transmitted using a frequency modulated signal.

In some embodiments, the apparatus may further comprise means for detecting a second event at said apparatus, and means for broadcasting a second control signal in response to said second event using a frequency modulated signal.

According to another exemplary aspect of the invention, an apparatus may be provided which may comprise means for receiving a first control signal on a frequency modulated signal, means for outputting audio signals, and means for changing at least one parameter of said audio signal output in response to said control signal.

### FIGURES

In the following, exemplary embodiments of the invention shall be described in more detail with reference to the appended figures, wherein

FIG. 1 shows an exemplary system of transmitter devices and a receiver device,

FIG. 2 depicts an exemplary method flow diagram illustrating muting of an audio output,

FIG. 3 depicts another exemplary method flow diagram illustrating a frequency change, and

FIG. 4 is an illustration of an exemplary receiver method flow when several transmitter devices are within the coverage range of a receiver.

It shall be noted that the Figures as well as the corresponding descriptions are only intended to provide a better understanding of exemplary embodiments, but shall not be understood to be limiting in any way.

### DETAILED DESCRIPTION OF EXEMPLARY EMBODIMENTS

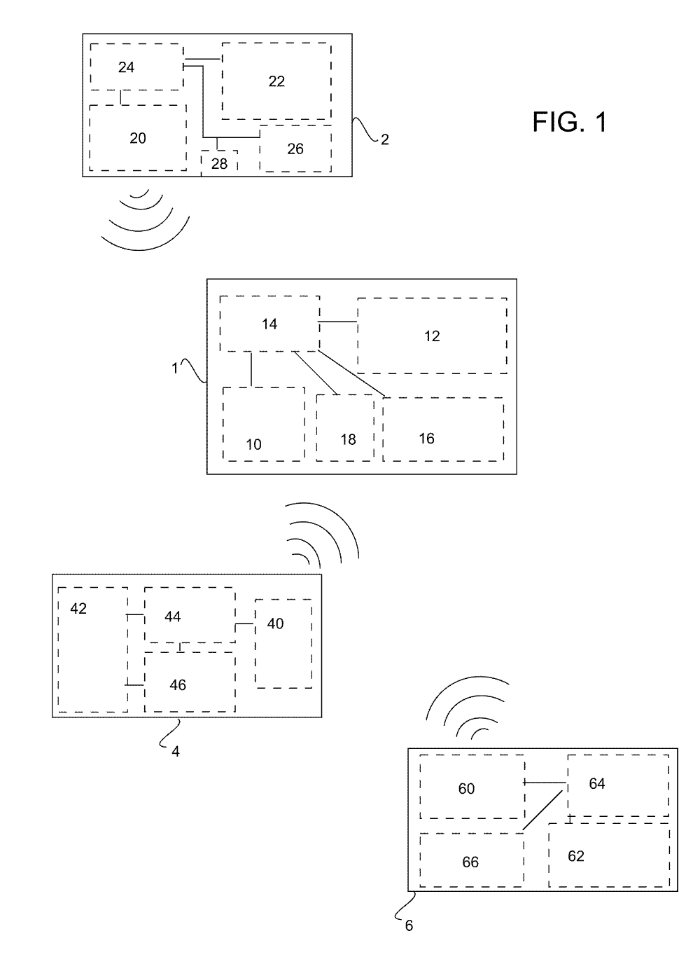

In FIG. 1, a system that may employ some features of the exemplary invention is shown. The exemplary system basically includes a radio receiver 10 and at least one short-range radio transmitter 20, 40, 60. As an example for a device 1 including a radio receiver 10, a car radio may be given. The short-range radio transmitter may be enclosed in a device 2, 4, 6 which requires some type of audio output to a user, such as a mobile phone 4, a music player 2, or a route guidance system 6. Many other electronic devices may implement some of the inventive functionalities, and naturally, the described types of devices may also be combined in a single device, and/or combined with additional functions, such as in a personal digital assistant or in a notebook computer. It shall be understood that the device described above as a radio receiver may also be a transceiver, and/or may have several receivers which may be able to be tuned to similar or different frequency bands. In the following, FMTx device, transmitter device and similar terms shall refer to any device 2, 4, 6 which includes at least a short-range FM transmitter 20, 40, 60 and a functional module 22, 24, 26. Short-range FM transmitters are known under various terms and standards. Examples are low power device (LPD), short-range device (SRD), or FM transmitter (FMTx). Transmitters of this kind may have various transmission ranges, but usually transmitting coverage may be in the range of several meters or dozens of meters. Besides the FM transmitter or transceiver module, the transmitter devices may include other modules and components such as cellular communication modules, wireless and wired communication interfaces, displays, touchscreens, keypads and keyboards, speakers, headphone terminals, processors, controllers, internal and removable memory elements, energy sources or connectors, and many more. The actual components of a transmitter device 2, 4, 6 will largely depend on the desired functionality of the device. Similarly, the receiver device 1 may have additional functionalities and corresponding components besides the FM receiver module and the audio output module (speakers), such as displays and signal lights, keys and other user input means, connectors, processors, memory elements, communication interfaces of any kind, and many more. The setup and functionality of such devices is known in the art and will not need to be discussed in detail.

In the example of FIG. 1, a music player 2 is shown that includes a short-range FM transmitter 20, a music player module 22, a controller 24, a user interface 26, and a connection interface 28. Each of the modules may include several components or elements, for example a user interface 26 may comprise several keys or wheels or a touch screen for user input, displays, and similar. A connection interface 28 may be a wireless or wired interface for data communication, such as a USB port or a Bluetooth connection, or a headset terminal. The controller 24 may be a main controller, which controls both the transmitter module and the music module; however, any of the components may also have separate controllers or processors. Finally, the music player module 22 may be a complete music player with its own controller, signal processing unit, and memory element, but it may also be a simple memory element having a music playback application controlled by the controller/processor 24. The other devices are constructed similarly; transmitter device 4 is a mobile phone including at least a cellular communication module 42, again an FM transmitter 40, a controller 44, and a user interface 46. The user interface 46 may likely be adapted to the telephone function in this case, such that it may e.g. include a display, speakers, a keypad or keyboard, and soft keys. The cellular communication module may, although not shown here, include memory elements, further controllers, antennas, coding and decoding elements, and many more components known in the art. The route guidance system 6 may include as a functional module a positioning module 62, a controller 64, an FM transmitter 60, and a user interface 66. Again, additional controllers, memory elements, processors, communication modules may be present as separate components or e.g. within the positioning module. The separate devices 1, 2, 4, 6, have only been shown as exemplary devices, and all of these may include other components, modules, or some components as shown may be omitted or combined. Also, while a separate main controller has been shown for all devices, it is also conceivable to have separate controllers or processing units for each module which are able to interact, e.g. a transmitter controller and a phone controller instead of controller 44 in mobile phone 4.

The FM transmitter may then be used to transmit audio signals from the transmitting device to any radio receiver located in its vicinity. The receiver may process the received audio signal and use loudspeakers connected to it for audio output. For example, the device including the FM transmitter may include a music player, but as often the case with mobile devices, may not have sufficient speakers or no speakers at all. By using the FM receiver as an external audio output system, size and elements in a mobile device may be reduced considerably. The music or other audio signals from the transmitting device may then be played via a car radio or any suitable receiver within the coverage range of the FM transmitter. However, in prior art system the user usually needs to control all parameters related to the output directly at the radio receiver, and cannot use any of the controls on the device which actually produces the sound signals.

In most radio receivers, a system called Radio Data System (RDS) is implemented. This allows transmitting certain supplement data with an audio data stream, such as a name or identifier of the current radio station, a current time signal, text information to be displayed such as a song title or contact phone numbers, traffic information, and many more. Certain codes may be assigned to specific information, such as unambiguous codes for each radio station, for easier communication. These signals are generally directed to use with high power commercial radio stations. The additional data is transmitted on a subcarrier of the actual carrier frequency as a modulation, in case of RDS at a 57 kHz subcarrier. In the RDS or RBDS protocol, information is transmitted in a group or block structure. Data groups are transmitted at a rate of approximately 11 groups per second. Each data group is made up of four blocks of information, with each block containing 26 bits. Those 26 bits include a 16 bit data portion and a 10 bit check word, or CRC, portion. Several group types are defined in the protocol, which types specify different configurations of data sent to a receiver. Further details of the well-known RDS system, which is a standard originally developed by the European Broadcasting Union, may be found in “RDS Universal Encoder Communication Protocol”, UECP version 5.1, European Broadcasting Union/RDS Forum, or also known as standard IEC 62106 (December 1999) from the International Electrotechnical Commission; and details of the similar US system Radio Broadcast Data System (RBDS) approved by the National Radio Systems Committee may be found in “United States RBDS Standard”, draft 2.0, August 1997. It shall be understood that the various embodiments of the invention are not limited to any of these standards or versions of same in particular, and that comparable systems may exist which allow to implement inventive features.

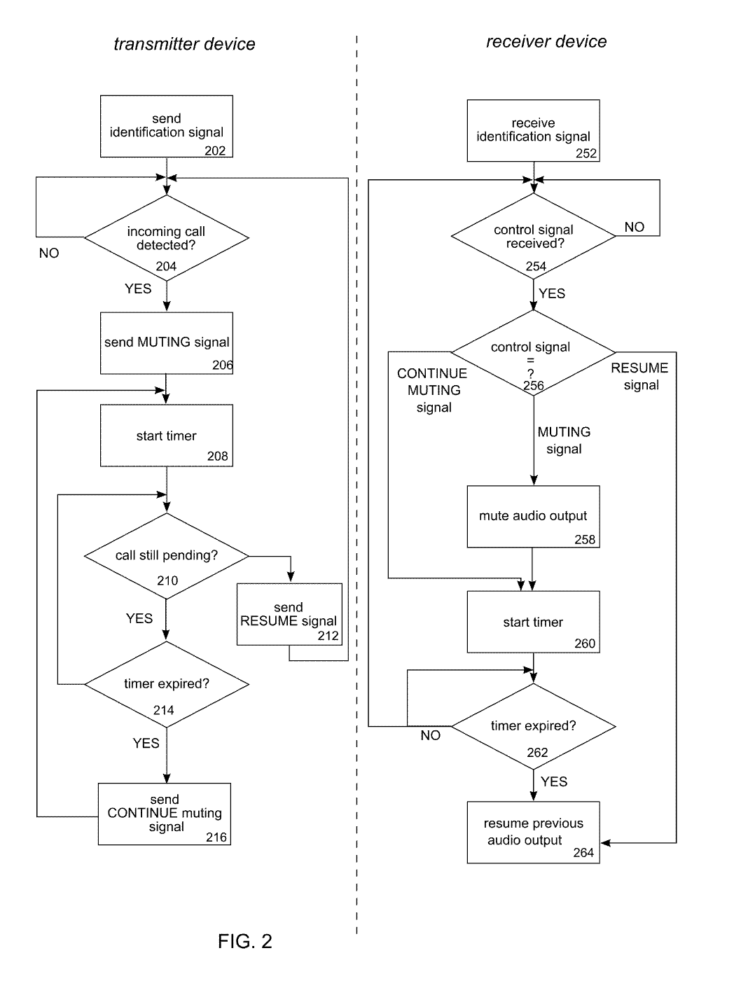

With embodiments of the inventive methods and devices, the RDS functionality or any similar system may be employed for controlling a radio receiver via an FMTx device. That is, an FMTx device within receiving range of a receiver may transmit an identification signal first, indicating that this is a short-range transmitter with enhanced functionality and not a “normal” radio station. After the identification signalling, various control signals may be transmitted from the FMTx device to the receiver when suitable. One example for such a control signal is a muting signal which may lead to temporary muting of the receiver audio output. This may be beneficial when the device having the FM transmitter is e.g. a mobile cellular phone, and an incoming call is detected. As a user would likely wish to have silence in order to answer the call, automatic muting of any other audio output while the call is ongoing may be achieved by control signals sent to the FM transmitter. It shall be noted that for such a muting control, the device does not necessarily have to use the FM transmitter for anything but the control function, i.e. not necessarily for audio broadcast. A more detailed description of this exemplary situation is given in conjunction with FIG. 2 below.

Another example for controls which may be applied by an FMTx device is a change of frequency, such that a device may tune from a high-power radio station frequency to the transmission frequency of the FMTx device. A possible application for such a feature would be any devices that require intermittent audio outputs to a user, such as a route guidance system. Whenever a new message is to be output, such as instructions to turn at a road crossing, the current program may be interrupted by a corresponding signal, and the receiver may switch to the FMTx frequency. Subsequently, the message or any other audio signal may be output via the receiver speaker system. In a slight modification from this exemplary situation, the receiver may switch from any of the currently active functions such as CD or mp3 playback to the radio receiver and play the audio signal as transmitted by the FMTx device. After the audio signal such as a navigation message has been completed, the receiver device may switch automatically back to the previous function, that is, the previous radio program or the CD player. Further examples for controls are volume control, equalizer control, and many others. In all cases, the control process may be triggered by any event such as a process executed within the FMTx device, a user input, or a signal received via other communication channels. While only a single receiver device is described here, signals broadcast by a transmitter device may be received by any FM receiver within the coverage area that is tuned to the correct frequency.

FIG. 2 depicts an exemplary method flow according to an embodiment of the invention. In the example of FIG. 2, the receiver device audio output is muted by the transmitter device in response to a certain event, for example in response to an incoming call. Upon activation of the transmitter device, a first signal may be transmitted for identification of the FMTx device, in step 202 (received by the receiver device in step 252). The signal may serve the purpose of both communicating some type of device identifier and for indicating that the control feature is supported or requested. As a device identifier, a code may be transmitted that will be valid for the current session, or optionally also a predefined code which will allow an enhanced receiver to recognize the exact type of device and the controls supported by the device. The indication of the enhanced control feature may be given by a flag, bit, or code within the identification signal, or alternatively by a registration signal transmitted before the identification.

The frequency for transmitting this identification or registration signal may be preset in the transmitter device, set manually by a user, or located via scanning for a quiet frequency using a method based on received signal strength such as RSSI (received signal strength indication). For a successful communication, the receiver has to be tuned to the same frequency as the transmitter, and this may again be achieved by e.g. manual user setup. The selected frequency, independent of the way it has been determined, may be shown on a display of the device that has determined the frequency, such that a user may tune other devices like the receiver to the same frequency. In another conceivable embodiment, a device may first try to find a suitable frequency for broadcast using RSSI as described above (or any other method providing similar results). After this frequency has been found, a frequency indication signal including some indication of the selected frequency may be broadcast repeatedly by this device, with the transmission frequency for this signal slowly scanning through the available frequency spectrum is done. It may be determined that this frequency indication is broadcast on all possible frequencies twice. A receiver tuned to any arbitrary frequency will then eventually pick up this signal while the transmitter scans through all frequencies, and can subsequently tune to the correct indicated frequency or at least store this frequency value for later use. Further parameters and data may be transmitted with the initial identification signal as desired.

When the frequency is set and the device has registered by transmission of the identification signal and/or further signals, control and audio signals may be broadcast from the FMTx device to the receiver at any time. The receiver may include further functionalities, such as a CD player or an mp3 player. After receiving an identification signal as described above in step 252, at least one FM receiver in the receiver device will listen on the determined frequency for signals (step 254), even when other functions of the device are used. That is, when a CD is played at a receiver device, it may constantly listen for control signals from the identified FMTx device. On the transmitter side, a control signal may also be sent out at any time when desired or necessary. In this example situation, the transmitter device may be a mobile phone having a short-range FM transmitter connected to the phone processing unit. When an incoming call is detected in step 204, the processing unit may issue a muting command to the transmitter, which may then broadcast this muting signal in a suitable way (step 206). Of course, further processors or controllers may optionally be connected in between, such that a phone module indicates the incoming call to an FMTx controller, which subsequently generates a signal for transmission. The actual signal may be a predefined code or sequence, and all possible control signals may be stored in a list or table at the transmitter device. The code to be transmitted, in this example a code that is understood as a muting command, may be selected from the list of available codes by the phone controller or the transmitter controller, or also by a common processing unit for both modules. The frequency used for transmitting this signal may be the frequency that has been used for the identification signal transmission, or a frequency that has been indicated during the start-up or identification sequence. It is, however, also conceivable that signals are transmitted during operation which indicate that another frequency shall be used for further signals, and a receiver detecting such a signal may then tune in to the frequency that has been indicated.

When the receiver receives this control signal, it may (after suitable signal processing) execute the command indicated by the control signal. For this purpose, it may determine the type of control signal received via a look-up table or similar means in step 256. In the present example, the control command is a muting command, resulting in the receiver device muting any current audio output (step 258). This may mean that the speaker signal is interrupted by a controller within the receiver, or that the current playback is paused similar to a user controlled “pause” function. The actual effect may be defined in the application controlling the receiver device, or alternatively by a flag in the command signal. Parameter flags or bits in the command signal would allow to use different “pausing” functions in different situations, or they would allow a user to predefine the desired pausing function via the transmitter device. Also, several devices may use different pausing functions with the same receiver if a flag, parameter, or something similar is provided within each command signal.

The period of muting may be ended either by the receiver, or alternatively by a further control signal from the transmitter. As a first embodiment or option, the transmitter based resume shall be discussed. When the phone call of this example has been terminated (indicated in FIG. 2 by step 210, when a call is no longer pending), usually by a user pressing a key or by termination of the connection, another control signal may be issued in step 212 by the transmitter device which indicates that normal operation may now be resumed, and muting is no longer required. (It should be noted that FIG. 2 also shows a timer function, which will be explained below for another embodiment.) Again, this resume signal may be issued by a phone module or a transmitter module or any common controller for the mobile phone and the transmitter elements. It will be understood that in other devices, such as route guidance systems or music players, similar controlling structures may be present, and that the control signals to the radio receiver may be issued by any of those. When a resume signal is received by the receiver in steps 254 and 256, including any kind of code or flag or sequence that indicates a resume command, the receiver may return to its original mode of operation in step 264. This may be the operation that has been performed before the muting signal has been received and executed, such as playing a radio station, playing a CD, or some other function provided by the receiver device.

Another possibility of a transmitter based resume function would be that the time after which the receiver should resume its previous operational mode is indicated in the first muting message. This embodiment is not explicitly illustrated in FIG. 2. This may be possible when the desired muting time is known by the FMTx device, as in the case of a message having a known length. When a user or any internal process within a transmitter device triggers broadcast of such a message, the length may be given by a length parameter in seconds or any other suitable unit. The muting signal broadcast to the receiver device will then include this length parameter, and optionally also further parameters that may be analysed by the receiver. The receiver device receiving the message may then start outputting the audio message using its speaker system while starting a timer having the indicated length parameter as an expiry time. Optionally, the receiver device may also add a period of time to the indicated message length when setting the timer period, such that it is ensured that the device will not resume its original operation before the message is ended.

When an FMTx device is intended to be muted temporarily, or to transmit in regular or irregular intervals only when required, one possibility would generally be to simply stop transmitting or to transmit silence. However, this is not allowed or desired in some radio standards. As an example, a transmitter may according to the ETSI standard (ETSI EN 301 357-1 V1.3.1 (2006-07) ERM: Cordless audio devices in the range 25 MHz to 2000 MHz) send silent signals for a maximum period of 1 minute; after this time, the frequency should no longer be blocked, such that a receiver may change frequency and try tuning to another station. With short interruptions of audio output like those for a phone call, the user may wish to resume the music playback or any other previous audio output after the muting. Also, if transmission would simply be stopped in silent periods, signals from commercial radio stations which happen to use the same frequency may suddenly be output, which is disturbing for the user. To comply with restrains such as those above, some embodiments may include timer functions on side of the receiver. Upon certain predefined commands, such as the muting command received and detected in step 256, a timer may be started (step 260) in the receiver device when the command is executed, i.e. for example on muting (step 258) the audio output. After the timer has expired (step 262), and thus after a preset period of time, operation on side of the receiver may return to whatever has been running before the respective command. While the timer has not expired, further control signals may still be received. As an example, if a muting signal is received and used for muting music playback from a CD, and a timer is set to an expiry time of 1 minute from start of the mute period, the receiver device may resume the playback (step 264) after this time has elapsed. The value of the expiry time may be preset in a receiver device, may be changeable by a user via any kind of interface, or may be transmitted with a signal from the FMTx device.

Since with such a feature the receiver would resume its original operation after a predefined period of time, the transmitter device may periodically transmit further signals (step 216) as long as the control function (e.g. muting) is desired to be maintained. These signals may be transmitted slightly before the timer on the receiver end would expire, in the example of a timer expiry time of 1 minute the messages may e.g. be sent every 55 seconds. The timing of the further control signals or “continue” signals may also be ensured by a timer on the transmitter end, which is started in step 208 when sending a control signal, and constantly or periodically checked for expiry (step 214). On the receiver device end, reception of such a continue control message may trigger a reset of the timer, which means that the timer may be restarted with the predefined expiry time (step 260). This will ensure that the muting is maintained as long as the transmitter device keeps sending such signals. In some embodiments, the continue signals transmitted for instructing the receiver to continue muting the signal may be different from the original muting control signals, while in other embodiments any further transmission of the same muting signal may indicate a required timer reset to the receiver device. When the muting or other control function is not required any more, the transmitter device may either simply stop to send further signals, such that the receiver device returns to its original function after the timer has expired, or a resume signal as described above may be broadcast to indicate that the receiver may immediately resume its functions.

It should be noted that in the example given above, it is assumed that the output sound signal for the phone call to the user is not transmitted via the FMTx, but output via a headset, a Bluetooth connection to an output device such as wireless headphones, or any other output feature available. However, in some cases the FMTx and thus the receiver audio output system may as well be used for outputting the phone voice signal to a user. It will also be understood that a temporary muting of environmental sound output (i.e. muting of the radio receiver) may not only be desirable when an incoming call is detected, but also in other situations. Another example is a call initiation by a user. After a user has dialled a number and pressed a key that results in a connection setup or during a connection setup that was started via voice dialling, the device may send a muting signal as similarly discussed for an incoming call. In this way, the user does not have to control two separate devices, but automatically has a silent environment when using his phone. In another exemplary situation, a FM transmitter device may perform a RSSI scan for finding quiet transmission frequencies which might be better than the frequency currently utilized. Before starting the scan, the device may then broadcast a muting signal to prevent that the receiver, which otherwise wouldn't know the reason for the lost transmission, tunes off or outputs noises received on the current frequency.

Optionally, the transmitter device may also include hardware or software options which allow a user to directly request muting of the receiver device, for example to have a short conversation. The signals transmitted may be similar to those of the phone call example; when a user presses a corresponding key or selects a software option for muting on the transmitter device, the muting signal may be broadcast. As this muting signal may be the same as that described above, the receiver device may again start a timer upon executing the muting command. Depending on the actual implementation, the transmitter device may automatically send continue muting signals to maintain the muting function until another user input indicates a request to end muting, or may not send additional signals unless the user presses a muting key once more. Some devices may also include user preference settings which may allow a user to change various parameters of such control signals.

Both the audio signals and/or the control signals may be encoded and/or compressed before transmission, and at the receiver end this would require a decompression and decoding step before the signals may be processed further. Various suitable methods are known in the art for both encoding and compressing radio signals, and these will not be discussed in detail here. Also, it is conceivable that encoding or compressing settings may be changed at a transmitter device.

“Continue” signals such as those described above for a muting embodiment, where further control signals are used to maintain a certain control status, may also be used in other embodiments. For example, it is conceivable to implement periodic control signals which indicate that the FMTx device is still active. A device may send such a signal, which may be referred to as a “status” or “confidence” signal, after a predetermined period of time. The moment of broadcasting this status control signal may be defined by preset timer elements at the transmitter device, similar to the continue muting signals above. Also, some embodiments may include that a broadcast of other signals (e.g. control or audio signals) will reset this timer, such that status signals are only transmitted when no other signals have been broadcast for some time. A status signal may include a device identifier and/or further parameters. On the receiver end, a status signal may indicate to the receiver device that the device is still active and the frequency is still correct, thus allowing to consider this device in all operations and processes as defined. It is also conceivable that a receiver which detects that no correct status signal has been received from a registered device for a certain amount of time will start some process, e.g. listening on all frequencies for new registration signals, or activating other predefined functions.

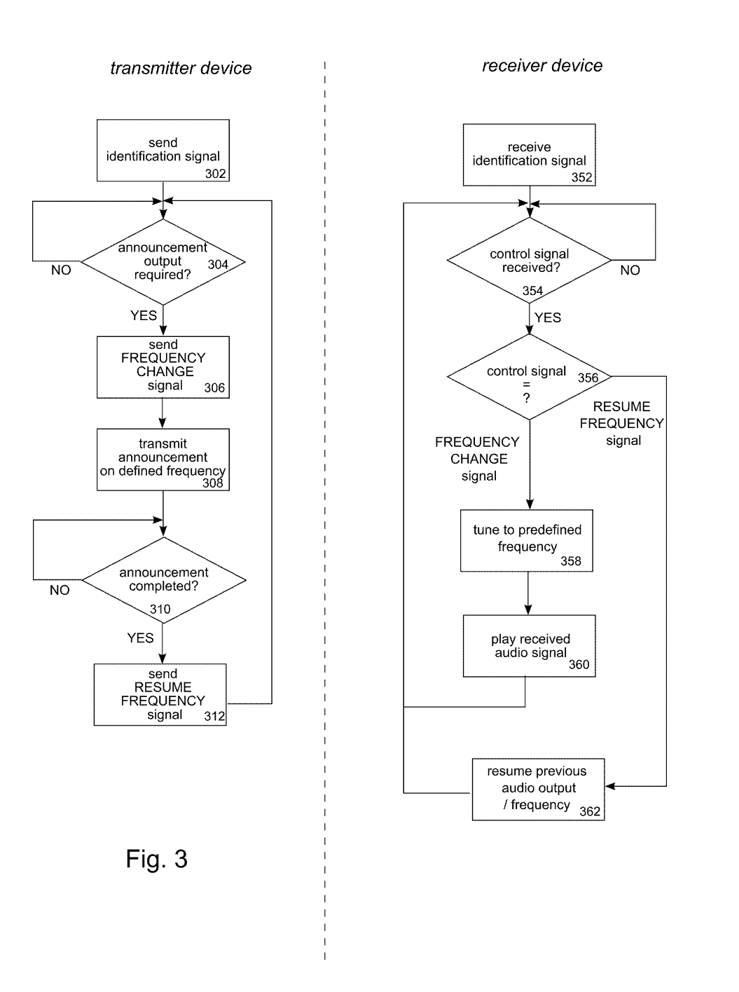

FIG. 3 is an example of a method flow for a frequency change, for example when a radio receiver is tuned to a certain frequency, but not to the frequency of the FMTx device in question. A frequency change may be used for short announcements or temporary sound output, with the possibility to return to the original frequency afterwards. The original frequency may be the frequency of a commercial high-power radio station, but also the transmitting frequency of a second FMTx device. An example of several short-range FMTx devices transmitting to a single receiver will be given in more detail below.

As in the previous example, a device would also first need to identify or register with the receiver device. For this purpose, an identification signal may be transmitted (step 302) from the transmitter device to the receiver device via the short-range FM transmitter. Details for this identification signal or message and any further signals for a registration process may be the same as in the muting signal example of FIG. 2. After successful transmission and reception (step 352) of the identification signal, a receiver may change to another frequency (e.g. a user selected radio station), as long as it keeps listening for control signals on the transmitter frequency (step 354). The transmitter frequency may be that one used for the identification signal, or alternatively a frequency that is indicated in the identification signal or any other signal from the transmitter device. For this and similar embodiments, a receiver needs to be able to tune to at least two frequencies simultaneously, whether it is by having several separate receivers, frequency filtering or any other method. However, this is only the case if it is desired to listen to a radio station or a FMTx device transmission on one frequency, and listen for control signals on another frequency, while a single receiver may be sufficient when announcements are made while using other functions of the receiver device which do not require any FM radio reception.

When an announcement or another audio signal needs to be broadcast by the transmitter device (step 304), such as a navigation/route guidance system issuing a navigation prompt, the transmitter device may transmit a frequency change signal in step 306, that is, a control signal instructing the receiver to change the audio output to the selected transmitter frequency. This signal may either be a signal already including the audio output, optionally together with a length indicator, or a mere control signal. As with other control signals, the frequency change command may be coded into the signal based on predefined code lists or tables, bit flags, or other signalling procedures. After the receiver device has received (step 354) and recognized (step 356) the frequency change command, it is required to switch its audio output system (e.g. the speaker system) to the frequency on which the command has been received in step 358. Subsequently, the transmitter device may stream the audio output signal (step 308) for playback at the receiver. While this signal is received and played (step 360), a second receiver of the receiver device may still be tuned to the previous commercial radio station, which allows to go back to this station after the transmitted audio signal has been completed. Otherwise, the previous frequency may be stored or buffered for resuming the original function. The end of the audio announcement (step 310) by the transceiver device may be indicated by a frequency resume signal transmitted to the receiver in step 312, similar to the resume signal after the muting of audio output in the above example. When this signal is received at the receiver device in step 354/356, this indicates that the receiver device may now return (step 364) to the radio frequency which has been tuned before the frequency change command, i.e. the signal indicates the end of the controlled process. If some type of length indicator or parameter for an audio message has been included in one of these signals, and if the receiver device is capable of analysing such a length indicator, it is also conceivable that the receiver device switches back to the previous device operation (in this case the previous radio station frequency) after completing the received output signal. It will be understood that in this case, some timer module at the receiver device may be set to the length indicated in the received length parameter, and that any timer module used for this purpose or for other purposes may be a software or hardware timer.

Similar to the examples of FIG. 2 and 3, control signals may be used not to command a frequency change or muting, but simply for the output of audio transmitted on a predetermined frequency. This may be useful for transmitter devices such as navigation systems, which may in this way use the speaker system of the receiving radio device even when the device is not used in any other way, or only for non-radio functions. When an announcement signal is received, the receiver device may switch the output to the radio receiver tuned to the transmission frequency of the FMTx device. Further details, such as the period of time the radio receiver is used for output, and the reception of further control signals, may be similar to the frequency change situation described above.

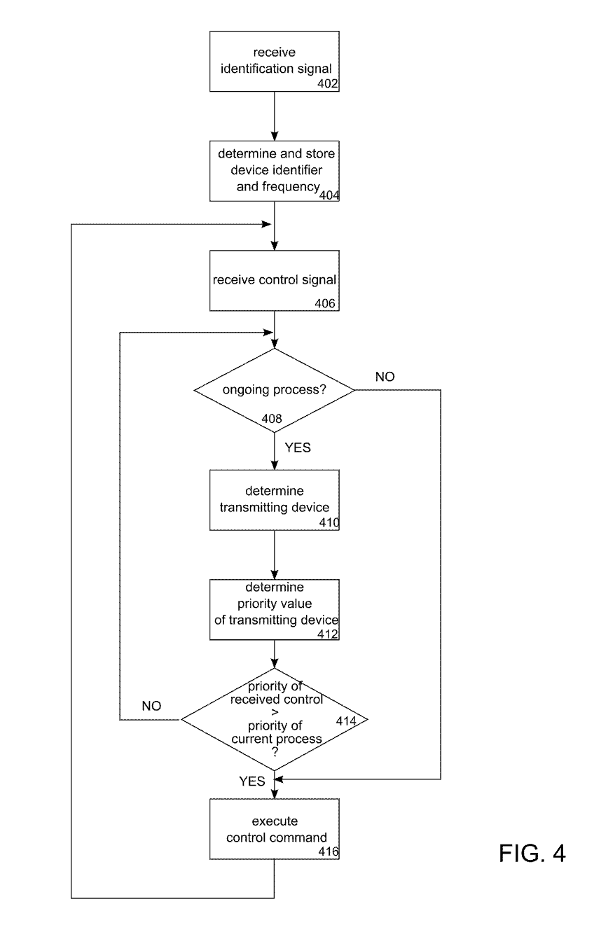

It is also conceivable to have several FM transmitters and thus several transmitter devices within the coverage range of a receiver device, and these may each have a selected transmission frequency. This situation is shown for the receiver device in FIG. 4. Each device may send identification and registration signals similar to those described in connection with FIG. 2. In the identification signal received in step 402, some type of unambiguous identifier may be given that may then be used by the receiver during the current session. The currently valid transmission frequency of the transmitter device may be stored together with its associated device identifier at the receiver device in step 404. It shall be noted that storage of such parameters in a local volatile or non-volatile memory may also be used in any of the other embodiments. In case of a non-volatile memory element available for parameters, these parameters and stored preference settings may also be used in later sessions as soon as the device is identified via its identifier transmitted during setup. In some embodiments, the identification signal may also include further parameters and identifiers which may allow a receiver to determine the class of device, such as “mobile phone”, “route guidance” or “music player”. If the device class is known, specific application preferences and even specific control signal codes may be given at the receiver device for each class. Generally, each of the connected transmitter devices may show some or all of the features described for exemplary embodiments. To associate received control signals to the correct device, each signal transmitted by a transmitter device may include the identifier.

In order to handle the interaction of several FMTx devices, a priority table or similar order parameters may be maintained at the receiver device. Parameters of this priority table may be predefined for each device class, or may be transmitted for each session by the transmitter devices themselves. For example, it is conceivable that at a receiver device, a high priority parameter (e.g. “2”) is stored for a mobile phone, and a low priority parameter (e.g. “4”) may be given for a music player, while an even lower parameter may be defined for normal radio playback of high-power radio stations. When one of these devices sends control signals which conflict with signals from other devices, the actual action may be determined by these priority parameters. As an example, a music player having a FM transmitter may be used for playing music via a radio receiver device. The receiver device may be tuned to the transmission frequency stored for this specific device. When a control signal is received from the mobile phone in step 406, identified by its device identifier transmitted within the control signal, the higher priority setting for the phone may result in the control signal to be executed. In contrast, if the priority setting for a device sending a control signal would be lower than that of a device currently playing, the control signal would not be executed. That is, the receiver device may first check in step 408 if any other process is currently active; if this is not the case, the control command can be executed directly (step 416). However, in the present example the active process checked in step 408 is the music playback from the music player transmitter device. If not already done, the receiver device may then determine the transmitting device (410) via the device identifier, and based on this the priority value of this device (step 412). When the priority is determined (414) to be higher than that of the current process, the control command is executed in step 416. This would be the case in the current example, where the mobile phone priority is 2 and the music player priority is 4. If the priority is lower, the control command is not executed. Optionally, an error message may be displayed to the user on one or both of the devices, or the control command may be buffered or delayed until the higher priority process (e.g. a muting command) is ended. In some embodiments, user inputs overriding certain priority settings may be defined at both the transmitter and the receiver device. In this way, a user may force a control command to be executed although the general priority setting of a device is lower than the currently active device.

In the priority example, a further device may be a navigation system/route guidance system associated with a priority parameter of “1”. It will be understood that the numbers used as priority settings are only given by way of example, and that other parameters and different indications may be given to indicate a priority. For example, a stack may be used by writing the device identifiers directly into a stack, such that control signals from a device being on top of the stack always have the highest priority, while control signals from a device on the bottom of the stack are only executed if they do not conflict with other signals. Returning to the example of three FMTx devices in the range of a single receiver, a frequency change command signal from the navigation system in order to output an audio announcement would override a muting command issued previously by the mobile phone, such that short navigational prompts are output even when the audio output is currently muted. On the other hand, the music playback (having a priority parameter of “4”) has a lower priority than both the mobile phone and the navigation system, such that a mobile phone muting command or a navigation prompt output would always be executed preferentially, such that music playback will be interrupted. When several devices grouped into the same device class are registered at a receiver device, e.g. two separate music players with FM transmitters, a user may be asked to provide a priority setting for these, or alternatively the priority may be set arbitrarily by the receiver device.

Priorities may also be given not based on device types, but application types, such that a device including a mobile phone and a music player may transmit control signals which will be handled with different priorities by the receiver. Also, priority settings may in some embodiments be changed by further control signals, or may be adapted to certain processes running at the receiver device. A priority value for a device or application is not necessarily the same for a complete session if some capability of priority changing is given. The order of priority for devices and applications as given above is to be understood as an example only. Another example would be that any emergency transmissions (which may be marked accordingly in the signal), e.g. announcements on a commercial radio station relating to accidents on highways, or to natural disasters, may have highest priority in a priority based system. The next priority value may be associated with navigation prompts and route guidance systems, then mobile phone calls, music players and finally with lowest priority commercial radio stations.

When a “continue” or “status” signal is used by FM devices as periodical indication of an active session, as has been described above, this signal may also be included in a priority functionality. For example, when no such “status” control signal has been received for a predetermined amount of time, the corresponding device may be seen as inactive and may thus be removed from the priority stack. That is, all devices or applications having lower priority may move up in a table or stack indicating priority settings. If preset values (e.g. “1” or “A”) are used to indicate priorities for a device, it may be sufficient to ensure that the device is not seen as a registered device any more, such that it would no longer be necessary to listen for control signals from this device. Also, a termination signal indicating a proper deactivation of a transmitter device may lead to the same behaviour as the loss of periodic status signals.

Furthermore, several FMTx devices registered may each have a selected transmission frequency which may be stored at the receiver device. In some embodiments, a single frequency may be used by all FMTx devices for transmitting control signals, while actual audio signal transmissions may be broadcast on another frequency indicated during registration/identification or within the control signal. In this way, a receiver device having only two receiver modules can still handle more than two FMTx devices by using one frequency for audio output, and another frequency as a dedicated “control channel”. A first transmitter device may send an audio signal for playback, e.g. music, on its dedicated transmission frequency. The first receiver is currently tuned to this first transmission frequency either manually or automatically, as described before. Simultaneously, the receiver device is tuned to another frequency with a second receiver module, a common control frequency for all registered transmitter devices. When a frequency change signal from a second transmitter device is received on that channel, and an optional priority setting is such that the frequency change shall be executed, the first receiver may be tuned to the transmission frequency of the second transmitter device while still using the second receiver for control signals. A setup like this may also ensure that muting signals or other control signals may be received at any time from any of the registered devices. Since only one audio signal can be output at a time, two receivers within the receiver device may be sufficient to handle a virtually unlimited number of transmitter devices. Still, more than two receivers may be present and may be actively used in accordance with any of the described embodiments.

When a transmitter device is turned off by a user, a termination signal may be broadcast in order to indicate to a receiver that no further control signals are to be expected. Depending on the settings of the receiver, this may result in “normal” receiver operation via the controls available at the receiver device, or the receiver device may be automatically turned off. If a deactivation feature is implemented, the receiver device may optionally mute output for a predefined period of time and only after this time turn off, thus ensuring that the turn-off was not accidental before terminating the session.

In all of the above embodiments, further events and processes may be associated with the transmission and reception of control signals. For example, when transmitting a muting signal, an indication such as a light signal, an icon or text display may be shown on the transmitter device and/or the receiver device, if any such display element is provided. In some embodiments, a frequency change signal transmission may be associated with a deactivation of audio output elements on the transmitter device, such as a headphone connector or a small speaker element. In this way, audio would only be output through either transmitter device or receiver device. Further, on the receiver end, audio signals received over FM radio after a frequency change signal or a similar control signal may be buffered to ensure that the correct frequency is tuned in before playing the audio. Alternatively, the transmitter device may delay the audio signal transmission slightly, e.g. transmitting the audio signal only a short period of time after the frequency change signal, such that the receiver device will have sufficient time for making all required settings. It should also be noted that a transmitter module within a transmitter device may be activated automatically (e.g. during device setup) or only on request, e.g. to save energy.

A number of specific commands may be given in form of a preset command list or code table, which may be stored at a receiver supporting at least some of the inventive functions. The respective command codes may be hard-coded ex factory in the receiver and transmitter devices, or they may be added as a software update later, if any update functionality is supported by the device. For example, there are radio receivers which have data communication ports such as Bluetooth, universal serial bus (USB) or other connection terminals, and these may be used for updating application software of a receiver. The update data or the hard-coded application data may include all allowable control signals, codes and parameters associated with these signals, actions to be performed in response to these signals, and many more.

All of the above described signals may be implemented as radio data system (RDS) or radio broadcast data system (RBDS) signals, and one possibility for implementing such control signals is the RDS open data application (ODA) functionality, an RDS feature providing flexibility for additional applications. Such applications may need to be registered separately with a standard committee or working group in charge. Generally, the current ODA feature allows for flexibly including additional functions which are not originally implemented in the RDS standard. A certain type of signal group may be reserved for registering ODA supporting applications, corresponding to the registration mentioned in the examples which indicates that the transmitting device is an enhanced device. It shall be noted that all “signals” or “messages” described above may be implemented according to the RDS and similar protocols, that is in a group and block structure of bits. In the current standard version, type 3A groups are reserved for application identification with ODA. In these type 3A groups (that is, the registration and identification signals), a first block of 16 bits is assigned to a program identification code, which may be used as a device identifier in inventive embodiments. After this identifier, a checkword of 10 bits follows. In the second code block of another 16 bits, four bits are assigned to the group type code of the group itself for identification, which is 0011 for the type 3 groups, plus an additional bit indicating the group type version (0 for A, 1 for B).

The next bit is usually used for a traffic program code, a single bit indicating whether traffic announcements are transmitted on a commercial station. As this is likely not relevant in a control application, this bit may be set to 0, indicating that the programme does not carry or refer to traffic information. The next five bits are assigned to program type codes which are predefined codes for usually indicating the kind of program playing on a radio station, such as “rock” or “news”. The program type may also be used for display at a receiver device. In an updated standard version or in similar standards, there may be codes defined particularly for FMTx short-range devices, such that a code may actually indicate the type of transmitter device, e.g. “navigation” or “mobile phone”. In such an embodiment, a transmitted program type code may even be used for defining functionalities and preferences, such as described above for priority settings or different muting schemes. When no such codes are defined or intended to be used, the bits may again be set to zero. The following four bits are defining the application group type code, which indicates which group type is to be used for the application in the transmission, plus one additional bit for the group type version. Several different group types are allowable in ODA applications, as mentioned in the standard and not detailed here. Another 10-bit checkword for the second block follows.

The next block and its associated checkword are assigned to message bits. Finally, in the last block, a 16-bit application identification code is transmitted, determining the software handler a receiver needs to user. Application identification codes need to be predefined for both transmitter and receiver. In this way, several control applications for different devices may be implemented, and these are identified via the unambiguous application identification code. With the last checkword, the group (registration/identification signal) is completed.

After registration, control signals may be transmitted using any of the allowable group types according to the ODA protocol. These control groups may include the device identifier (corresponding to the program identifier) in the first block, group type code and program type code in the next block, and all remaining bits may be used as defined for the specific application, e.g. for the muting signals, resume signals, termination signals, and any other control signals.

It shall be noted that the signal structure described above is not to be seen as limiting, but merely is an example of how embodiments of the invention may be implemented via the ODA functionality of RDS. In different data transmission standards or other versions of the same standard, structure, bit assignments and other features may change without affecting the desired functionality of the various inventive embodiments.

It shall be noted that a device which uses a FM transmitter for control of a receiver does not necessarily have to transmit audio signals. In the example given in FIG. 2, where an audio output is muted in response to an incoming call, it is also conceivable that the FM transmitter is mainly used for muting control without actually transmitting any audio data for speaker output. In other cases, the device may transmit both control signals and audio signals for output at the receiver device. Also, devices have been described as “transmitter device” or FMTx device and “receiver device” in accordance with their roles in the examples, but it will be understood that devices in some embodiments may have transceivers, or both a receiver and a transmitter module separately, and may thus both receive and transmit radio FM signals. In that case, each device may also assume the respective other function described in the examples. While various mobile devices and car radio receivers are one possible implementation embodiment, many other devices may also benefit from some or all inventive features. As an example, a home stereo system having a radio receiver may include embodiments of the invention, and virtually any device that requires at least temporary audio output (door bells, baby monitors, TV set, intercom) may use a FM transmitter in the ways described above. Thus, a baby monitor may transmit muting signals to the stereo whenever a signal is output, or may directly transmit the signal to a radio receiver, in order to prevent the monitor audio from being overheard.

Although exemplary embodiments of the present invention have been described, these should not be construed to limit the scope of the appended claims. Those skilled in the art will understand that various modifications may be made to the described embodiments and that numerous other configurations or combinations of any of the embodiments are capable of achieving this same result. Generally, any of the above functions may be combined in a device, or some functions may be partially or fully replaced by others. A device may include both a muting function and a frequency change function, and there may be embodiments having further simultaneous function and control situations. Also, the various implementations of control signals, priority settings, data transmission and similar are not limited to the examples given, but may be combined with each other and/or replaced by implementations having similar effects. Moreover, to those skilled in the various arts, the invention itself will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention.

What is claimed is:

1. A method comprising:
detecting a first event at a device; and
in response to said first event, broadcasting a first control signal including a control command, wherein said control signal is transmitted using a frequency modulated signal.

2. The method of claim 1, wherein said control signal includes a muting command.

3. The method of claim 1, wherein said control signal includes a frequency change command, and wherein a radio frequency parameter is indicated within said control signal.

4. The method of claim 1, wherein said first event is an incoming phone call.

5. The method of claim 1, wherein said first event is an audio announcement.

6. The method of claim 1, further comprising:
detecting a second event at said device; and
in response to said second event, broadcasting a second control signal using a frequency modulated signal.

7. The method of claim 6, wherein said second event is the termination of a phone call.

8. The method of claim 6, wherein said second event is the completion of an audio announcement.

9. The method of claim 1, further comprising starting a first timer having a predetermined expiry time, and on expiring of said time, sending a further control signal.

10. The method of claim 9, further comprising:
before said sending of a further control signal,
checking whether a process triggered by said first event is still active, and if said process is still active, restarting said first timer.

11. The method of claim 1, wherein said event is a user input.

12. The method of claim 6, wherein at least one of said events is a user input.

13. The method of claim 1, further comprising sending a termination control signal on deactivation of said device.

14. The method of claim 1, wherein said control signal is transmitted on a subcarrier of a frequency modulated carrier radio signal.

15. The method of claim 14, wherein said control signal is in accordance with the radio data system (RDS) standard.

16. The method of claim 15, wherein said control signal utilizes an open data application structure of the RDS standard.

17. The method of claim 1, further comprising broadcasting an identification signal using a frequency modulated signal upon start-up of said device.

18. A method comprising:
receiving a first control signal on a frequency modulated signal; and
in response to said control signal, changing at least one parameter of an audio output function.

19. The method of claim 18, further comprising:
storing a value of said at least one parameter before changing said parameter.

20. The method of claim 18, further comprising:
in response to said control signal, starting a timer having a expiry time, and on expiring of said timer, returning said at least one changed parameter of said audio output function to its original parameter value.

21. The method of claim 20, further comprising:
receiving a second control signal; and
in response to said second control signal, restarting said timer.

22. The method of claim 18, further comprising:
receiving a third control signal signal; and
in response to said third control signal, returning said at least one changed parameter of said audio output function to its original parameter value.

23. The method of claim 18, wherein said changing of audio output parameter includes muting an audio output signal.

24. The method of claim 18, wherein said changing of audio output parameter includes tuning to a defined receiving frequency.

25. The method of claim 18, wherein said changing of audio output parameter includes switching an audio output to radio frequency signals.

26. The method of claim 18, further comprising:
receiving an identification signal.

27. The method of claim 26, further comprising:
starting a control application in response to said identification signal.

28. The method of claim 26, further comprising:
storing parameters included in said identification signal.

29. A computer program product including computer program code which, when run on a processing device, executes the method of claim 1.

30. An apparatus comprising:
a frequency modulation radio transmitter module;
at least one functional module; and
a controller connected to said functional module and said transmitter module,
wherein said controller is adapted
to detect a first event at said functional module, and
to transmit a predefined control signal in response to said event.

31. The apparatus of claim 30, wherein at least one functional module is a cellular communication module.

32. The apparatus of claim 30, wherein at least one functional module is an audio player.

33. The apparatus of claim 30, wherein at least one functional module is a route guidance module.

34. An apparatus comprising:
a frequency modulation radio receiver module;
an audio output system including at least one speaker; and
a controller connected to said receiver module and said audio output system;
wherein said controller is adapted to
receive a first control signal on a frequency modulated signal, and to change at least one parameter of an audio output function in response to said control signal.

35. The apparatus of claim 34, further comprising a memory element,
wherein said controller is adapted to store parameters included in received control signals in said memory element.

36. An apparatus comprising:
means for detecting a first event at said apparatus; and
means for broadcasting a first control signal including a control command in response to said first event, wherein said control signal is transmitted using a FM radio frequency modulated signal.

37. The apparatus of claim 36, further comprising:
means for detecting a second event at said apparatus; and
means for broadcasting a second control signal in response to said second event using a frequency modulated signal.

38. An apparatus comprising:
means for receiving a first control signal on a frequency modulated signal;
means for outputting audio signals; and
means for changing at least one parameter of said audio signal output in response to said control signal.

39. A computer program product including computer program code which, when run on a processing device, executes the method of claim 18.
